(19) United States
(12) Patent Application Publication
(10) Pub. No.: US 2007/0256980 A1
(43) Pub. Date: Nov. 8, 2007

(54) Countercurrent systems and methods for treatment of contaminated fluids

(75) Inventors: John A. Krogue, Mineral Wells, TX (US); Timothy L. Holmes, Kingwood, TX (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: PERRY EQUIPMENT CORPORATION

(21) Appl. No.: 11/731,556

(22) Filed: Mar. 30, 2007

Related U.S. Application Data
(60) Provisional application No. 60/787,948, filed on Mar. 31, 2006.

(51) Int. Cl. C02F 1/28; C02F 1/42

(52) U.S. Cl. 210/688; 210/268

(57) ABSTRACT

A countercurrent system for treatment of contaminated fluid is provided. The system, in an embodiment, includes a source from which contaminated fluid may be introduced into the system and a reservoir of an adsorbent nanomaterial designed to remove contaminants from contaminated fluid. The system also includes a reactor in fluid communication with the reservoir, and within which a fluidized bed of the adsorbent nanomaterial can be accommodated in the presence of a countercurrent flow of contaminated fluid for the treatment of contaminated fluid. The system further includes a mechanism to maintain fluidity of the bed so that contaminated fluid introduced into the reactor can countercurrently flow through the bed. A pathway can also be provided along which treated fluid may be directed away from the container, as well as a collector for removing spent adsorbent material from the system. A method for treating contaminated fluid is also provided.

RELATED U.S. APPLICATION(S)

This application claims priority to U.S. Provisional Patent Application Ser. No. 60/787,948, filed Mar. 31, 2006, which application is hereby incorporated herein by reference.

### TECHNICAL FIELD

The present invention relates to systems and methods for treatment of contaminated fluids, and more particularly, to a countercurrent system and method for the removal of toxic heavy metals through the use of self-assembled monolayers on mesoporous supports.

### BACKGROUND ART

Produced fluid, such as water from offshore oil platforms can contain toxic heavy metals, for instance, mercury. In the Gulf of Mexico, mercury levels rarely exceed 100 parts per billion (ppb). However, in the Gulf of Thailand, the average concentration of mercury in produced water can range from about 200 ppb to about 2,000 ppb.

Discharge of mercury into the marine environment in U.S. territorial waters is currently regulated by the U.S. Environmental Protection Agency (EPA) under the Clean Water Act via the National Pollutant Discharge Elimination System permit process. According to environmental standards under 40 CFR § 131.36 for marine environment, limits include about 1800 ppb for acute exposure and about 25 ppb for chronic exposure. International standards for mercury discharges in produced water, on the other hand, range from about 5 ppb in Thailand to about 300 ppb in the North Sea.

Produced water often contains oil that was removed with the water during the bulk oil/water separation process. As an example, the produced water from the North Sea fields contains about 15-30 parts per million (ppm) dispersed oil with benzene, toluene, ethylbenzene, and xylene (BTEX); naphthalene, phenanthrene, dibenzothiophene (NPD), polycyclic aromatic hydrocarbon (PAH), phenol, and organic acid concentrations ranging from about 0.06 ppm to about 760 ppm. Additionally, these produced waters contain toxic heavy metals, such as mercury, cadmium, lead, and copper in concentrations ranging from less than about 0.1 ppb to about 82 ppb. The presence of a complex mix of constituents coupled with a high concentration of dissolved salts can present a challenge for heavy metal removal using currently available conventional technologies.

In particular, existing technologies for metal and mercury removal from diluted wastewater include activated carbon adsorption, sulfur-impregnated activated carbon, microemulsion liquid membranes, ion exchange, and colloid precipitate flotation. These technologies may not suitable for water treatment because of poor metal loading (e.g., metal uptake less than 20% of the mass of the adsorber material) and selectivity, (interference from other abundant ions in groundwater). In addition, mercury may be present in species other than elemental. So the method implemented must be able to remove these other species, such as methyl mercury, etc. Furthermore, they lack stability for metal-laden products so that they are not disposable directly as a permanent waste form. As a result, secondary treatment is required to dispose or stabilize the separated mercury or the mercury-laden products. Mercury removal from non-aqueous sludge, adsorbed liquids, or partially- or fully-stabilized sludges, and mercury-contaminated soil is difficult because (1) the non-aqueous nature of some wastes prevents the easy access of leaching agents, (2) some waste streams with large volumes make the thermal desorption process expensive, and (3) the treatment of some waste streams are technically difficult because of the nature of the wastes.

Mercury removal from offgas in vitrifiers and in mercury thermal desorption processes is usually accomplished through activated carbon adsorption. However, the carbon-based adsorbents are only effective enough to remove 75 to 99.9% of the mercury with a loading capacity equivalent to 1-20% of the mass of the adsorber material. A last step, mercury amalgamation using expensive gold, usually is needed to achieve the EPA air release standard. A carbon bed usually is used later in the offgas system, where the temperature is generally lower than 250° F. In the sulfur impregnated carbon process, mercury is adsorbed to the carbon, which is much weaker than the covalent bond formed with, for instance, surface functionalized mesoporous material. As a result, the adsorbed mercury needs secondary stabilization because the mercury-laden carbon does not have the desired long-term chemical durability due to the weak bonding between the mercury and active carbon. In addition, a large portion of the pores in the activated carbon are large enough for the entry of microbes to solubilize the adsorbed mercury-sulfur compounds. The mercury loading is limited to about 0.2 g/g of the materials.

The microemulsion liquid membrane technique uses an oleic acid microemulsion liquid membrane containing sulfuric acid as the internal phase to reduce the wastewater mercury concentration from about 460 ppm to about 0.84 ppm. However, it involves multiple steps of extraction, stripping, demulsification, and recovery of mercury by electrolysis and uses large volumes of organic solvents. The liquid membrane swelling has a negative impact on extraction efficiency.

The slow kinetics of the metal-ion exchanger reaction requires long contacting times. This process also generates large volumes of organic secondary wastes. One ion exchange process utilizes Duolite™ GT-73 ion exchange organic resin to reduce the mercury level in wastewater from about 2 ppm to below about 10 ppb. Oxidation of the resin results in substantially reduced resin life and an inability to reduce the mercury level to below the permitted level of less than about 0.1 ppb. The mercury loading is also limited because the high binding capacity of most soils to mercury cations makes the ion-exchange process ineffective, especially when the large amounts of Ca²⁺ from soil saturate the cation capacity of the ion exchanger. In addition, the mercury-laden organic resin does not have the ability to resist microbe attack. Thus, mercury can be released into the environment if it is disposed of as a waste form. In addition to interference from other cations in the solution besides the mercury-containing ions, the ion exchange process is simply not effective in removing neutral mercury compounds, such as HgCl₂, Hg(OH)₂, and organic mercury species, such as methylmercury, which is the most toxic form of mercury. This ion-exchange process is also not effective in removing mercury from non-aqueous solutions and adsorbing liquids.

The reported removal of metal from water by colloid precipitate flotation reduces mercury concentration from about 160 ppb to about 1.6 ppb. This process involves the addition of HCl to adjust the wastewater to pH 1, addition of Na₂S and oleic acid solutions to the wastewater, and removal of colloids from the wastewater. In this process, the treated wastewater is potentially contaminated with the Na₂S, oleic acid, and HCl. The separated mercury needs further treatment to be stabilized as a permanent waste form.

Acidic halide solution leaching and oxidative extractions can also be used in mobilizing mercury in soils. For example KI/I₂ solutions enhance dissolution of mercury by oxidization and complexation. Other oxidative extractants based on hypochlorite solutions have also been used in mobilizing mercury from solid wastes. Nevertheless, no effective treatment technology has been developed for removing the mercury contained in these wastes. Since leaching technologies rely upon a solubilization process wherein the solubilized target (e.g. mercury) reaches a dissolution/precipitation equilibrium between the solution and solid wastes, further dissolution of the contaminants from the solid wastes is prevented once equilibrium is reached. In addition, soils are usually a good target ion absorber that inhibits the transfer of the target ion from soils to solution.

The removal of mercury from nonaqueous liquids, adsorbed liquids, soils, or partially-or-fully-stabilized sludge at prototypic process rates has been lacking. This is mainly because the mercury contaminants in actual wastes are much more complicated than the mercury systems addressed by many laboratory-scale tests that are usually developed based on some simple mercury salts. The actual mercury contaminants in any actual wastes almost always contain inorganic mercury (e.g., divalent cation Hg²⁺, monovalent Hg₂²⁺, and neutral compounds such as HgCl₂, Hg[OH]₂,); organic mercury, such as methylmercury (e.g., CH₃HgCH₃ or CH₃Hg⁺) as a result of enzymatic reaction in the sludge; and metallic mercury, because of reduction. Since many laboratory technologies are developed for only one form of mercury, demonstrations using actual wastes are not be successful.

Other metals that are of interest for remediation and industrial separations include but are not limited to silver, lead, uranium, plutonium, neptunium, americium, cadmium and combinations thereof. Present methods of separation include but are not limited to ion exchangers, precipitation, membrane separations, and combinations thereof. These methods usually have the disadvantages of low efficiencies, complex procedures, and high operation costs.

Accordingly, it would be advantageous to provide a system and method that can be used to remove heavy metals, such as mercury, cadmium, and lead from complex waste fluids, such as produced water, in a significant amount and in a cost effective manner.

### SUMMARY OF THE INVENTION

The present invention, in one embodiment, provides to a countercurrent system for treatment of contaminated fluid. The system, in an embodiment, includes a source from which contaminated fluid may be introduced into the system, a reservoir for an adsorbent material for use in removing contaminants from the fluid, a reactor within which a fluidized bed of the adsorbent material may be accommodated and within which the contaminated fluid may be permitted to flow upwardly in a plug-flow manner, and a mechanism to maintain fluidity of the bed so that contaminated fluid introduced into the reactor can countercurrently flow through the bed. The system can also include a pathway along which treated fluid may be directed away from the reactor, and a collector for removing spent adsorbent material from the system.

The present invention, in another embodiment, provides a method for treatment of contaminated fluid. The method includes initially providing a fluidized bed of an adsorbent nanomaterial within an environment, such as a reactor, where contaminated fluid can be treated. Next, a flow of contaminated fluid into the environment from an opposite direction to where the adsorbent material was added, so that the fluid can flow countercurrently through the bed. Thereafter, the adsorbent nanomaterial in the fluidized bed is allowed to interact with the contaminated fluid as the fluid flow countercurrently through the bed, so that the adsorbent nanomaterial can attract and remove contaminants from the fluid. Once moving through the bed and reaching one end of the environment, the treated fluid can be discharged from the environment.

### BRIEF DESCRIPTION OF DRAWINGS

FIG. 1 illustrates a countercurrent system for use in the treatment of contaminated fluids.

### DESCRIPTION OF SPECIFIC EMBODIMENTS

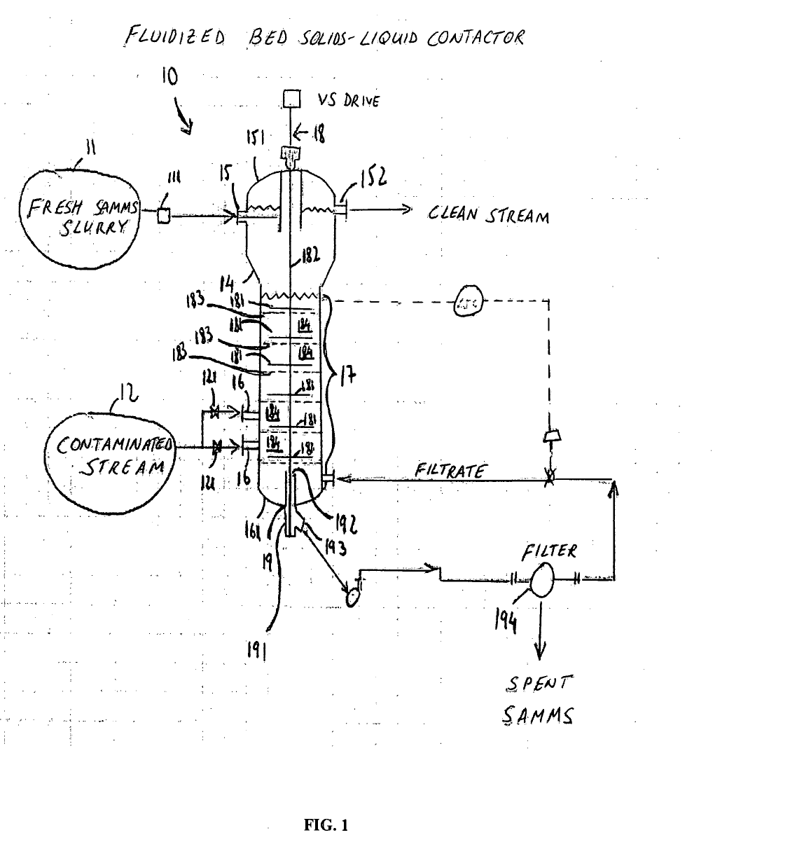

With reference to FIG. 1, the present invention provides, in one embodiment, a system 10 for treating contaminated fluid by removing therefrom contaminants that exist within the fluid. Fluids which may be treated in connection with the present invention may be viscous, such as oil, or non-viscous, such as a liquid or a gas. Contaminants that may be removed by the system of the present invention includes heavy metals, such as mercury, cadmium, and lead from complex fluids or waste streams, such as produced water, and mercury from a variety of waste solutions and contaminated waste oils.

The system 10, in an embodiment, includes a reservoir 11 within which a waste adsorbent material capable of removing contaminants from a waste fluid may be stored. The waste adsorbent material, in one embodiment, may be a nanosorbent material (i.e., adsorbent nanomaterial) manufactured from self-assembled monolayers on mesoporous supports (SAMMS). It should be appreciated that reference to the term “adsorbent material” hereinafter includes nanosorbent material or adsorbent material, either of which may be used interchangeably with the other. The mesoporous supports, in one embodiment, may be made from various porous materials, including silica. An example of a SAMMS material that can be used in connection with body portion 11 of the present invention includes thiol-SAMMS, such as that disclosed in U.S. Pat. No. 6,326,326, which patent is hereby incorporated herein by reference.

In accordance with one embodiment of the present invention, the waste adsorbent material may be porous particles, each ranging from about 5 microns to about 200 microns in size. In one embodiment, the particles, on average, range from about 50 microns to about 80 microns in size, include a pore size ranging from about 2 nanometers (nm) to about 7 nm, and may be provided with an apparent density of ranging from about 0.2 grams/milliliter to about 0.4 grams/milliliter. The adsorbent material, in an embodiment, may be treated in order to functionalize the particles. Specifically, within the pores of the mesoporous SAMMS (i.e., the adsorbent material), the monolayer of chemical may be functionalized to subsequently bind the molecules of specific contaminants, such as heavy metals, along with other constituents within the fluid as the fluid flows through the pores.

To permit ease of introduction into the system 10 and ease of flow therealong, the adsorbent material may be provided as a slurry mixture. In particular, the waste adsorbent material may be mixed with a liquid, such as water, to provide the necessary slurry mixture. This slurry mixture may, in an embodiment, be maintained in a mixed form within reservoir 11 by methods known in the art, for example, by any mechanical devices or fluid injection mechanism capable of creating a necessary turbulence. Alternatively, it should be appreciated that as the slurry mixture is introduced into the system 10, the natural turbulence of the contaminated fluid stream may be sufficient to generate the desired mixing. Should it be necessary or to further enhance mixture of the slurry, a mixer (not shown), such as a static mixer commercially available through many outlets in the industry, may be provided immediately downstream of the reservoir 11. The presence of this static mixer can further optimize the mixing of the slurry as it flow along the system 10.

To control the introduction of waste adsorbent material into system 10, a metering pump 111 may be provided to permit either manual or automatic control of an amount that the waste adsorbent material can be introduced into the system 10. The amount of waste adsorbent material introduced can be critical, as will be noted below, since an appropriate amount needs to be determined in order to provide an optimum waste removal capacity for the system 10.

Still looking at FIG. 1, the system 10 may also include a source 12 from which contaminated fluid may be introduced into the system 10. In accordance with one embodiment, the contaminated fluid may be waste fluid, such as produced water generated in connection with oil or gas drilling. The contaminated fluid, in an embodiment, may be introduced into system 10 at a controlled rate, so that an appropriate amount of the waste adsorbent material can be determined for introduction into the system 10. In particular, the amount of adsorbent material that may be needed can be proportional to the flow rate of the fluid and the amount of contaminant within the fluid flow. Generally, the amount of contaminant will be constant, so that the flow rate of the fluid will be a parameter which needs to be controlled.

To control the flow rate of the fluid, a flow control valve 121 may be provide downstream of source 12. In addition, a flow-meter (not shown) may be provided between the source 12 and the flow control valve 121 to help in determining the flow rate before control valve 121 is adjusted to an appropriate level. It should be noted that system 10 may not need such a control valve should the flow rate be capable of being adjusted from the source 11 based on the reading on the flow-meter.

The system 10 may also include a countercurrent reactor 14 for treatment of contaminated fluids. In one embodiment, reactor 14 provides an environment within which a fluidized bed of adsorbent material may be accommodated over a period of time. During this time period, the contaminated fluid may be introduced at a bottom end of the reactor 14 and allowed to flow upward, in a “plug-flow” manner through the fluidized bed. As the contaminated fluid moves through the fluidized bed, contaminants from the fluid may be adsorbed by the waste adsorbent material and removed from the fluid until an acceptable concentration of contaminants within the fluid has been reached. The period of time, in an embodiment, can be determined by the kinetics of the adsorption of the contaminants into the waste adsorbent material and by the diffusion time of the contaminants within the fluid flow into the waste adsorbent material, and may last from about less than two minutes of about thirty minutes or more if necessary. In one embodiment, the period of time may also be dependent upon the size, and in particular, the diameter of the reactor 14. Diameter size of the reactor, in one embodiment, is a function of minimum fluidization velocity, which, in turn, can be a function of the size of the adsorbent material (i.e., SAMMS particles). The diameter of the reactor 14 can vary with particle size, up to about the 1.82 power.

Still referring to FIG. 1, in accordance with an embodiment of the present invention, reactor 14 may be provided with a slurry inlet 15, at top end 151, through which the slurry of adsorbent material may be introduced into the reactor 14. The reactor 14 may also include a waste fluid inlet 16 at bottom end 161 through which contaminated fluid may be introduced into the reactor for countercurrent processing. The adsorbent material, in one embodiment, may be provided with sufficient weight to settle toward bottom end 161 to form a fluidized bed 17, so that contaminated fluid may move (i.e., rise) in a countercurrent manner upward toward top end 151 of reactor 14, subsequent to its introduction through inlet 16. It should be appreciated that multiple inlet 16 may be provided at bottom end 161 to permit more volume of the contaminated fluid or different contaminated fluids to be introduced into reactor 14. In addition, although not shown, it should be noted that the flow into inlet 15 and inlet 16 may be controlled by an individual valves. These inlet valves, in an embodiment, may be automatically actuated or electronically controlled. To the extent desired, these valves may be designed to also be manually actuated.

The fluidized bed 17, as it should be appreciated, should remain substantially fluid to permit fluid to move therethrough. To the extent that the bed 17 may be substantially packed down by its weight, operation of the reactor 14 may be compromised. To ensure that the fluidized bed 17 may remain substantially fluid, a mixing mechanism 18 having sweeping blades 181 connected to a drive shaft 182 may be provided. The presence of the blades 181 can generate sufficient turbulence that may be sufficient to permit fluid to flow therethrough, but sufficiently low to avoid mixing of the adsorbent material with the treated fluid at the top end 151 of the reactor.

In order to further minimize mixing or back-mixing of the adsorbent material with the fluid in reactor 14, and in particular, with the treated fluid, reactor 14 may be provided with a plurality of perforated plates 183, each being positioned at a particular height along the length of the reactor 14, so that the adsorbent material may be relatively contained between plates 183 during operation. In this manner, reactor 14 may be divided into a series of compartments 184. Moreover, the perforations in each plate 183, in an embodiment, may be sufficiently porous, so as to permit the adsorbent material to flow downward therethrough into an adjacent compartment 183 below.

As illustrated in FIG. 1, the position of the plates 183 may be such that one blade 181 of the mixing mechanism 18 may be situated within one compartment 184. Accordingly, sufficient turbulence within the compartment 184 may be generated to permit fluid being treated to move upwardly in an appropriate plug flow manner, while imparting plug flow characteristics to the adsorbent material as it moves downward. In one embodiment, due to the design of the reactor 14, the bottom-most compartment may not have a blade 181 positioned therein. To the extent that the adsorbent material may be larger than about 500 microns in size, the perforated plates 183 may not be necessary, since the adsorbent material of such size tend to settle in a plug flow manner with minimal back-mixing.

It should be appreciated that the presence of blade 181 in each compartment 183 may also provide intermittent plug flow within each compartment to maintain fluidity of the bed 17. In particular, the adsorbent material and fluid being treated may be designed flow in a countercurrent manner (i.e., in opposite directions) relative to one another within reactor 14. As such, when each blade 181 passes substantially over the perforations of its respective plate 183, the flow of fluid upward through the perforations may be blocked, and the flow of adsorbent material downward within the compartment 184 increases, since the upward flow of fluid no longer counteracts the downward flow of the adsorbent material. However, the adsorbent material may be substantially blocked from flowing through the perforations into an adjacent lower compartment 184. Subsequently, when each blade 181 moves beyond the perforations and the perforations may no longer be blocked, the adsorbent material may again be permitted to flow through the perforations down to an adjacent lower compartment 184. However, shortly thereafter, as the upward flow of fluid may be reestablished across the perforations, the flow of adsorbent material downward at such time decreases. To that end, intermittent flow may be provided.

In order to further enhance the intermittent flow, in one embodiment, the mixing mechanism 18 may be provided with a variable speed agitator 185, so that the speed (i.e., revolution per minute) can be matched to the processing rate of the adsorbent material. In other words, the speed of the blades 181 may be set so that the downward flow of the adsorbent material within the bed 17 from one compartment 184 into an adjacent lower compartment 184 can be substantially similar to the flow rate of the slurry mixture of adsorbent material across the inlet 15 into reactor 14 and the flow rate of the adsorbent material out of the reactor 14.

Reactor 14 may also include, at its bottom end 161, outlet 19 through which used or spent adsorbent material from fluidized bed 17 may be removed. In one embodiment, outlet 19 includes an outlet pipe 191 circumferentially situated about drive shaft 182, such that an opening 192 may be provided at a top end of pipe 191 to permit adsorbent material from the fluidized bed 17 to enter. Outlet 19 can also include an exit port 193 through which the adsorbent material may exit from the outlet pipe 191.

Reactor 14, in an embodiment, may further include, at its top end 151, outlet 152 through which treated fluid may exit. In particular, as contaminated fluid rises through the fluidized bed 17 and contaminants removed by the time the fluid flow has reached the top end 151 of reactor 14, the fluid flow may be substantially devoid of contaminants. The presence of outlet 152 thereat permits treated fluid to be directed out from the reactor 14. Control of outlet 19 and outlet 152 may be by individual valves (not shown), which may be automatically or manually actuated.

Although illustrated with only one reactor 14, system 10 may be designed to include at least two or more substantially similar reactors to allow a continuous treatment process to be implemented. In other words, with at least two reactors, one reactor, for example, reactor 14, may have its spent adsorbent material replaced or regenerated, while the other reactor, may be used in the countercurrent process to remove contaminants from contaminated fluids. These reactors can also be designed to be in fluid communication with one another. In that way, treated fluid in one reactor can be directed into another reactor to permit further treatment, if necessary, including removal of additional contaminants not removed in the previous reactor by the adsorbent material that may have been functionalized to remove only certain contaminants.

The system 10 may further be provided with a separation device 194 for the removal of spent adsorbent material. In one embodiment, the separation device 194 may be a filter designed with pores or mesh openings capable of preventing particles, such as the adsorbent material, ranging from about 5 microns to about 200 microns in size from moving thereacross. Alternatively, the separation device may be a centrifuge-type separation device. Such a device, in an embodiment, uses centrifugal force to concentrate spent adsorbent material at the bottom of the device. A collector may also be provided in connection therewith, so that the spent adsorbent material concentrated at the bottom of the device may be directed into the collector and removed from system 10.

System 10 may also include a discharge valve and flow-meter (not shown) for use in connection with the discharge of cleaned or treated fluid from the system, subsequent to its exit from the outlet 152. The flow-meter can help to determine the flow rate of the cleaned fluid while the discharge valve can be used to control the discharge rate relative to the flow rate.

In operation, reactor 14 may start out being empty of either the adsorbent slurry and/or the contaminated fluid. In this empty state, slurry inlet 15 and contaminated fluid inlet 16 of reactor 14 may be in the closed position. Thereafter, inlet 15 and inlet 16 of reactor 14 may be opened, so that the slurry of adsorbent material (i.e., SAMMS) and the contaminated fluid may be introduced into reactor 14. Once the fluidized bed 17 has been established by the adsorbent material, contaminated fluid may move upward, in a plug-flow manner through the fluidized bed 17. As the fluid rises through the fluidized bed, the adsorbent material, as mentioned above, can act to remove the contaminants from the contaminated fluid to provide substantially clean fluid. In particular, in the presence of the adsorbent material, which in one embodiment, may be mesoporous SAMMS, the meso-porosity of the SAMMS permits the fluid to flow through the pores in the SAMMS. Within these pores, particular contaminants, such as a heavy metal (e.g., mercury), come in contact with a monolayer of chemical designed to attract and bind the molecules of these contaminants, along with the other constituents of the fluid flow. As such these particular contaminants may be trapped within the SAMMS and removed from the fluid flow

As contaminated fluid continues to rise through the fluidized bed 17 and contaminants removed, by the time the fluid flow has reached the top end 151 of reactor 14, the fluid flow may be substantially devoid of contaminants. The treated fluid may thereafter be directed out of the reactor through outlet 152.

In accordance with one embodiment of the present invention, the used or spent adsorbent material may be removed using various approaches. In one approach, as the adsorbent material makes it way down the reactor across the various chambers 184, the spent adsorbent material may be permitted to exit through outlet 19 by way of outlet port 193. Thereafter, the adsorbent material may be allowed to flow along pathway 195 across a filter 194 where the spent adsorbent material may be trapped and fluid carrying the adsorbent material to the filter may be permitted to flow therethrough as a filtrate. The filter 194, in an embodiment, may be provided with pores that are substantially smaller than the adsorbent material while still sufficiently large to permit the fluid to move therethrough. As filter 194 becomes full with the spent adsorbent material, it may be isolated and removed along with the adsorbent material. A new filter may be put in place for subsequent removal of the adsorbent material. To provide continuous operation, system 10 may be provided at least two filters in parallel, so that the adsorbent material can continue to be filtered, while the full filter is being replaced.

In an alternate approach, the system 10 may utilize the centrifuge-type separation device (not shown). This device, as noted above, uses centrifugal force to concentrate the spent adsorbent material at the bottom of the device. Once at the bottom of device, the adsorbent material may be removed and directed to a collector. The spent adsorbent material may thereafter be disposed or regenerated for subsequent use.

The filtrate, once moved beyond filter 194, may, in one embodiment, be redirected (i.e., recirculated) back into reactor 14 through inlet 162 into a bottom-most compartment 184. The recirculation of the filtrate back into the bottom-most compartment 184 may be used, in an embodiment, to control the flow of the adsorbent material out of such compartment through outlet 19. In particular, should the filtrate flow not be recirculated into the bottom-most compartment 184, in the absence of blade 181 to provide the necessary turbulence, the adsorbent material may settle and get compacted at the bottom end 161 of reactor 14. Once within the reactor, the filtrate may be permitted to flow upward through the various compartments 184, be retreated by the adsorbent material, and directed from the reactor 14 as treated fluid when it reaches the top end 151 of the reactor 14.

To regenerate the adsorbent material for subsequent use, the adsorbent material may be treated with an acidic fluid to remove the adsorbed contaminant. After this regeneration process, the adsorbent material may be put back in service to again remove the contaminants.

It should be appreciated that, although shown in the embodiment illustrated, other countercurrent reactors may be used in connection with the method of the present invention. For instance, countercurrent reactors having a mechanical mixing mechanism similar to those disclosed in U.S. Pat. No. 3,801,370, U.S. Pat. No. 3,881,876, U.S. Pat. No. 5,490,976 may be used. Alternatively, countercurrent reactors with no mechanical mixing mechanism such as those disclosed in U.S. Pat. No. 6,491,826 may be used. These patents are hereby incorporated herein by reference.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains.

What is claimed is:

1. A system for treatment of contaminated fluid, the system comprising:
a reservoir of an adsorbent nanomaterial designed to remove contaminants from contaminated fluid;
a reactor in fluid communication with the reservoir, and within which a fluidized bed of the adsorbent nanomaterial can be accommodated in the presence of a countercurrent flow of contaminated fluid for the treatment of contaminated fluid; and
a mechanism to maintain fluidity of the bed so that contaminated fluid introduced into the reactor can countercurrently flow through the bed.

2. A system as set forth in claim 1, wherein the adsorbent nanomaterial in the reservoir includes a porous particle made from self-assembled monolayers on mesoporous supports (SAMMS).

3. A system as set forth in claim 2, wherein the particle is made from silica.

4. A system as set forth in claim 2, wherein the particle has a pore size ranging from about 2 nanometers (nm) to about 7 nm.

5. A system as set forth in claim 1, wherein the adsorbent nanomaterial has an apparent density ranging from about 0.2 grams/milliliter to about 0.4 grams/milliliter.

6. A system as set forth in claim 1, wherein the adsorbent nanomaterial is capable of removing heavy metal contaminants from the fluid.

7. A system as set forth in claim 6, wherein the heavy metal contaminants include mercury, arsenic, cadmium, lead, silver, uranium, plutonium, neptunium, americium, other heavy metals, or a combination thereof.

8. A system as set forth in claim 1, wherein the contaminated fluid is viscous in nature.

9. A system as set forth in claim 8, wherein the viscous fluid includes one of oils, waste oils, other fluid viscous in nature, or a combination thereof.

10. A system as set forth in claim 1, wherein the contaminated fluid is non-viscous in nature.

11. A system as set forth in claim 10, wherein the non-viscous fluid includes a liquid or a gas.

12. A system as set forth in claim 10, wherein the non-viscous fluid includes produced water.

13. A system as set forth in claim 1, wherein the reactor includes an inlet, positioned at one end of the reactor, to introduce contaminated fluid into the reactor and a different inlet, positioned at an opposite end of the reactor, to introduce the adsorbent nanomaterial into the reactor.

14. A system as set forth in claim 1, wherein the reactor includes a first outlet for removal of treated fluid from the reactor.

15. A system as set forth in claim 1, wherein the reactor includes a second outlet for removal of spent adsorbent nanomaterial from the reactor.

16. A system as set forth in claim 1, wherein the mechanism to maintain fluidity of the bed includes a mixing device having at least one blade that can generate sufficient turbulence so as to permit countercurrent flow through the bed, while avoiding mixing of the adsorbent nanomaterial with treated fluid.

17. A system as set forth in claim 1, further including a feedback pathway to recirculate back into the reactor fluid recovered from a slurry of spent adsorbent nanomaterial removed from the reactor.

18. A system as set forth in claim 17, wherein the fluid recirculated back into the reactor can aid in maintaining fluidity of the bed.

19. A system as set forth in claim 1, further including wherein the collection device in communication with the reactor to collect the spent adsorbent material.

20. A system as set forth in claim 19, wherein the collection device is a centrifugal force type device capable of concentrating spent adsorbent material at a bottom of the device.

21. A system as set forth in claim 19, wherein the collection device is a filter having pores or mesh openings capable of collecting the adsorbent nanomaterials thereon for removal.

22. A system as set forth in claim 1, further having at least one additional reactors to permit a continuous treatment process to be implemented.

23. A method for treating contaminated fluid, the method comprising:
providing a fluidized bed of an adsorbent nanomaterial within an environment where contaminated fluid can be treated;
introducing a flow of contaminated fluid into the environment, so that the fluid can flow countercurrently through the bed;
allowing the adsorbent nanomaterial in the fluidized bed to interact with the contaminated fluid as the fluid flow countercurrently through the bed, so that the adsorbent nanomaterial can attract and remove contaminants from the fluid; and
discharging treated fluid from the environment.

24. A method as set forth in claim 23, wherein the step of providing includes providing a source of contaminated fluid to be treated and a reservoir of the adsorbent nanomaterial.

25. A method as set forth in claim 23, wherein, in the step of providing, the adsorbent nanomaterial includes a porous particle made from self-assembled monolayers on mesoporous supports (SAMMS).

26. A method as set forth in claim 25, wherein the step of introducing includes providing a slurry of SAMMS having an apparent density ranging from about 0.2 grams/milliliter to about 0.4 grams/milliliter

27. A method as set forth in claim 23, wherein the step of introducing includes directing the contaminated fluid into the environment from an opposite direction which the adsorbent material is introduced into the environment.

28. A method as set forth in claim 23, wherein, in the step of introducing, the countercurrent flow is in a plug-flow pattern.

29. A method as set forth in claim 26, wherein, in the step of introducing, the contaminated fluid is viscous in nature.

30. A method as set forth in claim 29, wherein, in the step of introducing, the viscous fluid includes one of oils, waste oils, other fluid viscous in nature, or a combination thereof.

31. A method as set forth in claim 26, wherein, in the step of introducing, the contaminated fluid is non-viscous in nature.

32. A method as set forth in claim 31, wherein, in the step of introducing, the non-viscous fluid includes a liquid or a gas.

33. A method as set forth in claim 31, wherein, in the step of introducing, the non-viscous fluid includes produced water.

34. A method as set forth in claim 26, wherein, in the step of allowing, the period of time ranges from less than about 2 min. to about 30 min or more.

35. A method as set forth in claim 26, wherein the step of allowing includes permitting the adsorbent nanomaterial to remove heavy metal contaminants from the fluid.

36. A method as set forth in claim 35, wherein, in the step of permitting, the heavy metal contaminants include mercury, arsenic, cadmium, lead, silver, uranium, plutonium, neptunium, americium, other heavy metals, or a combination thereof.

37. A method as set forth in claim 26, wherein the step of allowing includes permitting the adsorbent nanomaterial to bind and trap the contaminants within the nanomaterial.

38. A method as set forth in claim 26, further including collecting spent adsorbent nanomaterial having contaminants attracted thereto.

39. A method as set forth in claim 26, further including providing a plurality of similar environments within which contaminated fluid can be treated, so as to implement a substantially continuous treatment process.
